(19) United States
(12) Patent Application Publication
(10) Pub. No.: US 2007/0186748 A1
(43) Pub. Date: Aug. 16, 2007

(54) Interchangeable Die Press System and Method

(75) Inventors: Lisa Corcoran, Laguna Beach, CA (US); David L. Hughes, Rancho Santa Margarita, CA (US); Kevin L. Corcoran, Mission Viejo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ellison Educational Equipment, Inc., Lake Forest, CA (US)

(21) Appl. No.: 11/672,495

(22) Filed: Feb. 7, 2007

Related U.S. Application Data
(62) Division of application No. 10/623,125, filed on Jul. 17, 2003, now abandoned.
(60) Provisional application No. 60/397,337, filed on Jul. 18, 2002.

(51) Int. Cl. B26D 1/00; B26D 5/08

(52) U.S. Cl. 83/651; 83/529; 83/588

(57) ABSTRACT

Disclosed is a die press cutting system that includes a commercial die press including a working area with a cutting height, a consumer die adapted to be located in the working area of a consumer press with a cutting height smaller than the cutting height of the commercial press, a consumer die having a steel rule height that is custom or specific to the consumer press working area, and an adapter having a thickness or height that is generally approximately equal to the difference between the height of a commercial die and the height of the consumer press die.

### CROSS-REFERENCES TO ELATED APPLICATIONS

This application is a divisional of application Ser. No. 10/623,125, filed Jul. 17, 2003, which claims priority to provisional application No. 60/397,337, filed Jul. 18, 2002, both of which are hereby incorporated by reference.

### BACKGROUND OF THE INVENTION

The present invention relates to sheet cutting presses and, more particularly, a system and method for utilizing interchangeable components for commercial and consumer sheet cutting presses utilizing a die with a custom steel rule height.

Dies and sheet cutting presses are used to cut various patterns out of sheet materials. The presses are designed to apply uniform pressure to a platen and die to cut through a sheet or a plurality of sheets simultaneously. Typically, the sheets are placed between the die and a cutting pad with a cutting position of the die extending through the sheets and slightly into the cutting pad when pressure is applied to the die. Die presses are used commercially as well as by consumers and the respective commercial and consumer die presses each have dies and cutting pads that are designed with an overall height that cooperates with the working or cutting area for each respective press. The working area of a die is located between the upper platen and the lower platen.

### BRIEF SUMMARY OF THE INVENTION

Disclosed is a die press cutting system that includes a commercial die press with a working area having a cutting height, a consumer die adapted to be located in the working area of a consumer press with a cutting height smaller than the cutting height of the commercial press, a consumer die having a height that is custom or specific to the consumer press working area, and an adapter having a thickness or height that is generally approximately equal to the difference between the cutting height of a commercial die and the cutting height of the consumer press die.

In another aspect of the invention, disclosed is a die press cutting system as essentially described above, wherein the adapter includes a cutting pad and the overall thickness or height of the adapter is generally approximately equal to the difference between the cutting height of a commercial die and the cutting height of the consumer press die.

In yet another aspect of the invention, disclosed is a die press cutting system essentially described above, which further includes a cutting pad.

In another aspect of the invention, disclosed is a cutting die with a base, a die with a custom height extending from the bottom of the base to beyond the top of the base, and a rubber layer adhered to the top of the base which extends from the top of the base beyond a cutting edge of the die.

### BRIEF DESCRIPTION OF THE DRAWINGS

The invention will now be described in greater detail with reference to the preferred embodiments illustrated in the accompanying drawings, in which like elements bear like reference numerals, and wherein:

FIG. 1 is a schematic representation of the different die press systems;

FIGS. 2 and 2A-2E are side elevational views of a commercial press in an open position with different combinations of dies, adapters and/or cutting pads according to the present invention;

FIG. 3 is a side elevational view of the commercial press shown in the closed position;

FIG. 4 is a front elevational view of the commercial press shown in an open position;

FIG. 5 is a front elevational view of the commercial press shown in a closed position;

FIG. 6 includes a top plan view of a consumer die with a steel rule having a custom steel rule die height;

FIG. 6a includes a cross sectional side view A-A taken from the top plan view;

FIG. 7 is a front prospective view of a consumer die press in an open position;

FIG. 8 is a front prospective view of the consumer die press in a closed position;

FIG. 9 is a front elevational view of the consumer die press in an open position;

FIG. 10 is a front elevational view of the consumer die press in a closed position illustrating a cutting height;

FIG. 11 is a side elevational view of the consumer die press in an open position;

FIG. 12 is a side elevational view of the consumer die press in a closed position;

FIG. 13 is a perspective view of an adapter; and

FIG. 14 is an end view of the adapter.

### DETAILED DESCRIPTION OF THE INVENTION

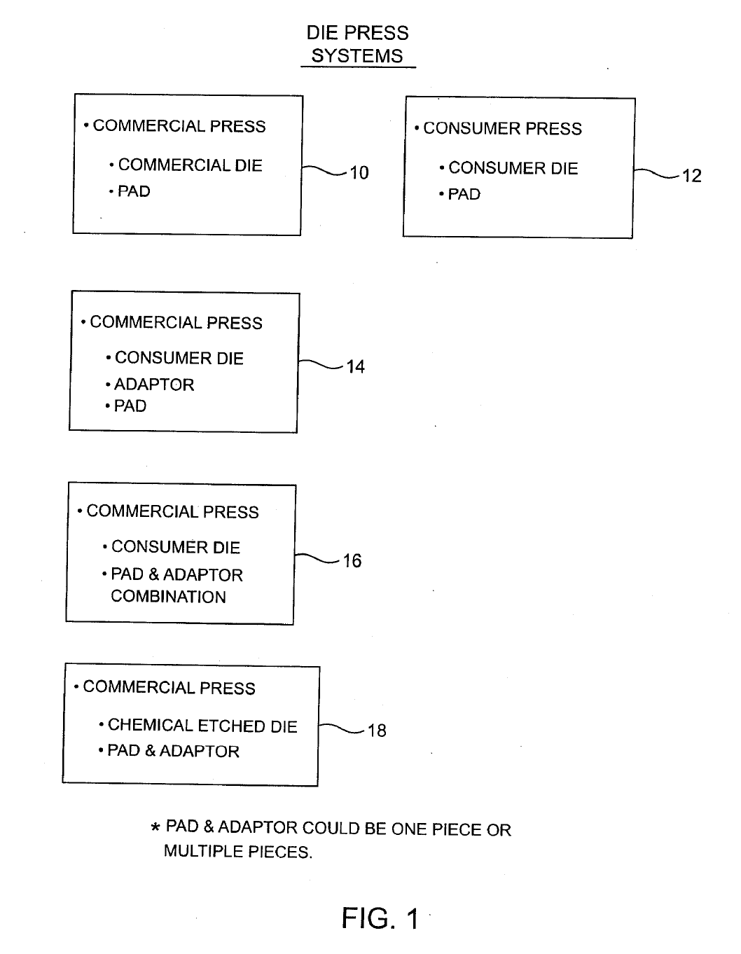

Incorporated herein by reference in its entirety is U.S. Pat. No. 5,255,587 which is assigned to the assignee of the present application. According to the present disclosure, as shown in FIG. 1 die press cutting systems include one or more components from a commercial press system and one or more components from a consumer press system. Commercial presses are typically larger in size with larger components, such as larger dies and possibly a larger or thicker cutting pad. In contrast, the consumer press is typically smaller in size and utilize smaller dies and possibly smaller or thinner cutting pads relative to the commercial press system components. Commercial presses also create more forces when compared to consumer presses. Commercial press 10 includes a commercial die with a cutting pad. A cutting material such as sheets of paper, leather, plastic, or some other material is placed between the commercial die and the cutting pad during operation of the commercial press. Independent from the commercial press is a consumer press 12, which includes the components of at least one consumer die and a cutting pad. The commercial dies have an overall height that is greater than the consumer die heights since the commercial press is larger than the consumer press and, as will be further described below, the working or cutting area of the commercial press is larger than the working or cutting area of the consumer press. The cutting area of a die press is referred to as a working area since the dies may be used for embossing sheet materials as well as for cutting sheet materials.

According to the present disclosure, a commercial press 14 may further include the components of a consumer die and an adapter, and a cutting pad. In the alternative, a commercial press 16 may include at least one consumer die, and a combination cutting pad and adapter. Further yet, in the alternative, according to the present disclosure a commercial press 18 may include a thin die, such as a chemical etched die, and an adapter or special cutting pad or a combination cutting pad and adapter. According to the present disclosure, the cutting pad and the adapter could be a combination of multiple pieces or could be combined to be one piece.

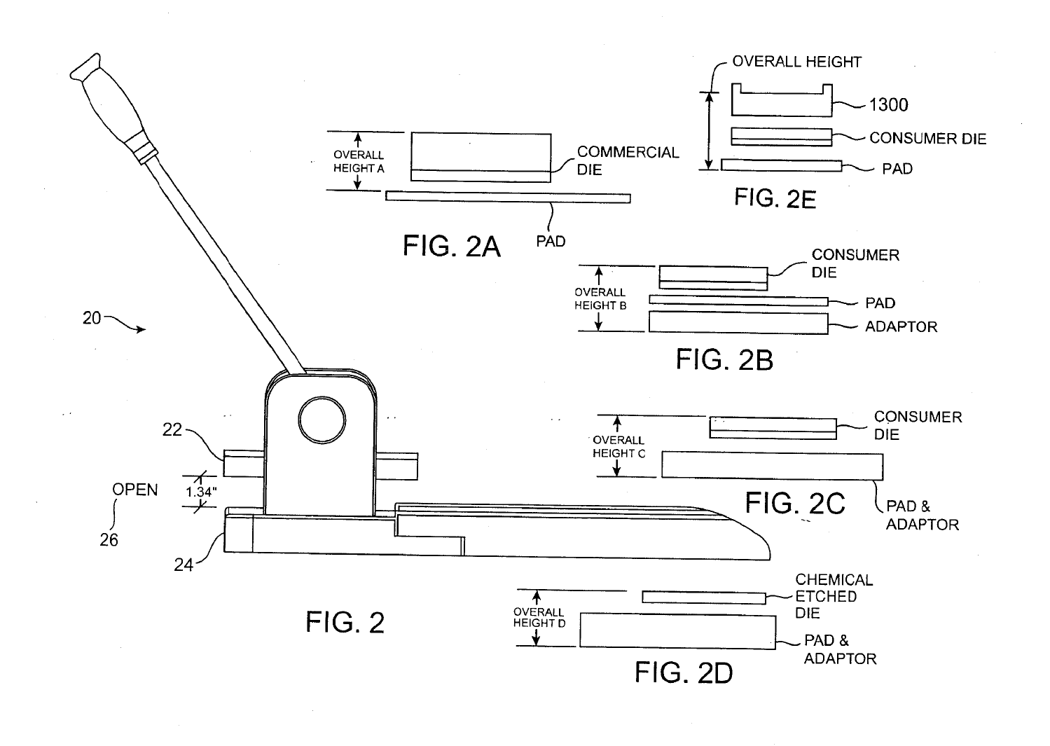

As shown in FIG. 2, according to the present disclosure the die press cutting system includes a commercial die press including a working area with an open height and a closed cutting height, a consumer die is adapted to be located in the working area of a consumer press, wherein the consumer press has a cutting height smaller than the cutting height of the commercial press. The consumer die has a height or a steel rule that is custom or specific to the consumer press working or cutting area, and an adapter having a thickness or height that is generally approximately equal to the difference between the cutting height of a commercial die and the cutting height of the consumer press die. A different sized adapter could be used with thin die, such as a chemical etched die.

Further as shown in FIG. 2, a commercial press 20 is shown in the open position with an upper platen 22 and an opposing lower platen or base 24:. The commercial press 20 is shown in the open position defining a working area with an open position 26.

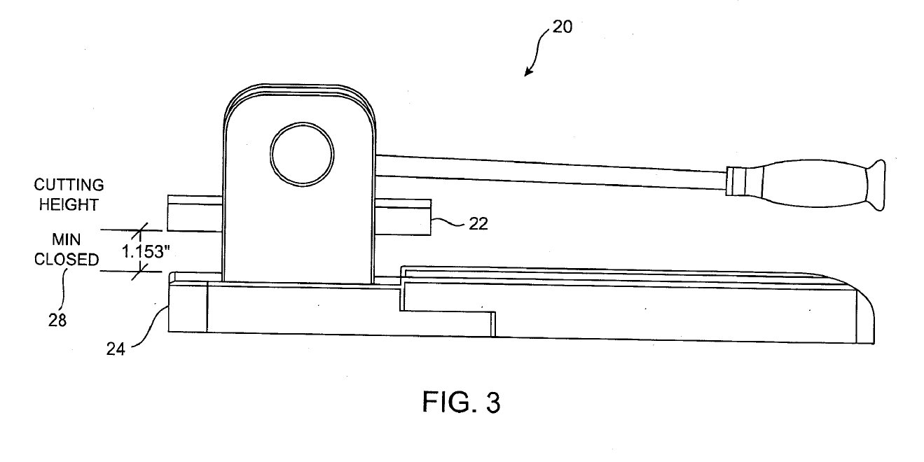

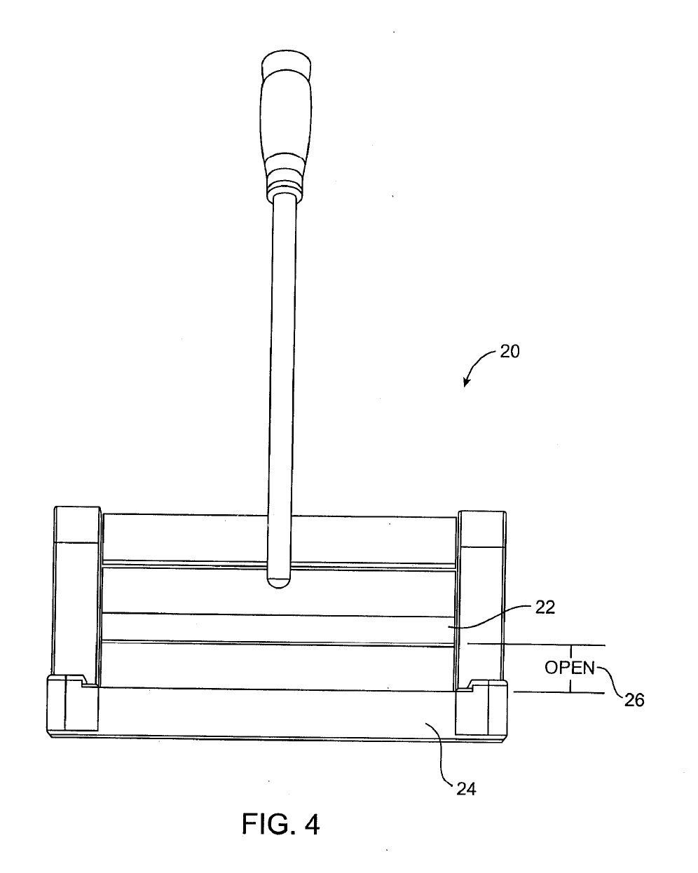

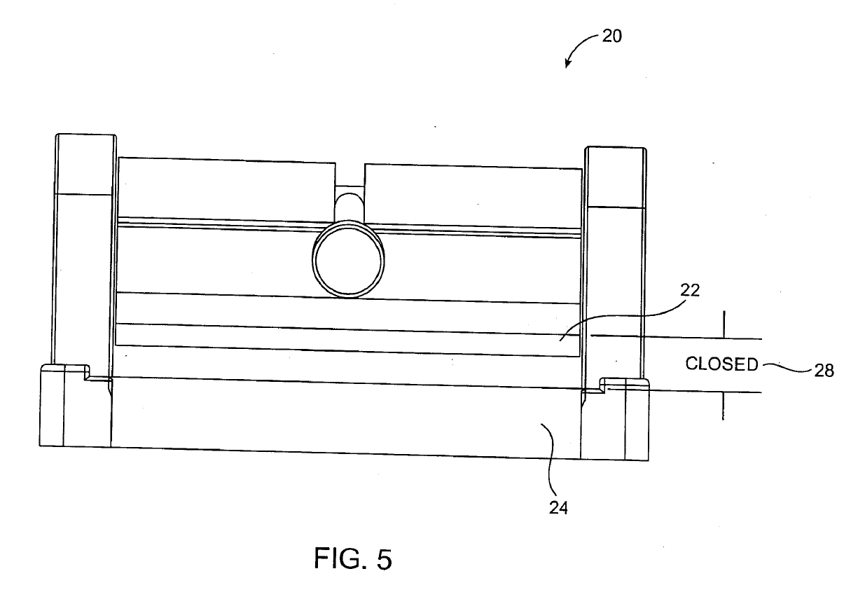

FIG. 3 illustrates the commercial die press in the closed position defining a cutting height 28 between the upper platen 22 and the lower platen or base 24. Likewise, FIG. 4 illustrates a commercial press in the open position defining the open area 26 and FIG. 5 illustrates the commercial die press in the closed position defining the cutting height 28.

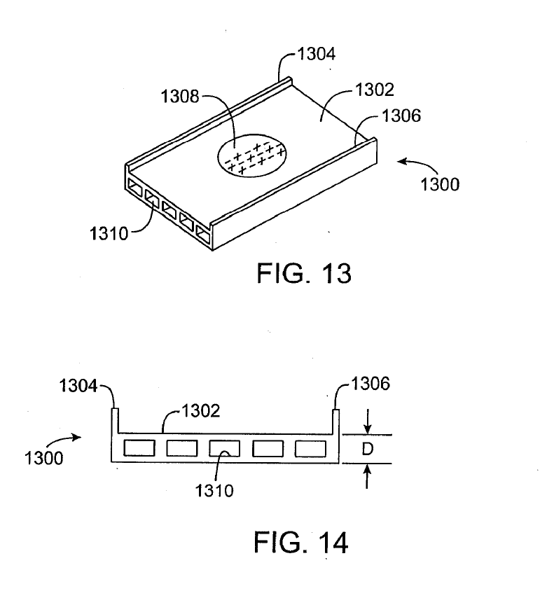

As will be further explained below, and as shown in FIG. 2, and according to the present disclosure, the commercial die press 20 may utilize a combination of components from different systems, including a commercial die and a cutting pad to define an overall height A as shown in 2A. In the alternative, the commercial die press 20 may utilize a combination of components and arrangements from different systems, such as a consumer die, a cutting pad, and an adapter in which all three define an overall height B as shown in 2B. And yet in another alternative, a consumer die may be used in combination with a combined cutting pad and adapter in which the components define an overall height C as shown in 2C. And yet in another embodiment, a commercial die press 20 may utilize a combination of a thin die, such as a chemical etched die and a combination cutting pad and adapter, or a cutting pad and adapter with the components defining an overall height D as shown in 2D. As will be described in more detail below, an adapter such as the adapter shown in FIG. 13 may be used with a thin die and a cutting pad as shown in 2E. The thin die may be a chemical etched die. In every combination disclosed herein, the overall height of the die combination cooperates with the commercial press 20 so that the combination of different system components will easily fit into the working or open area when the commercial die press is in the open position. Further yet, the overall height of the die combination allows the proper amount of force and yield so as to allow a cutting action, as will be further described below, when the commercial die press 20 is in the closed or cutting position. Therefore, the die combinations disclosed herein are adapted to operate with the cutting height of the commercial die press 20, even though the components may be intended for different systems.

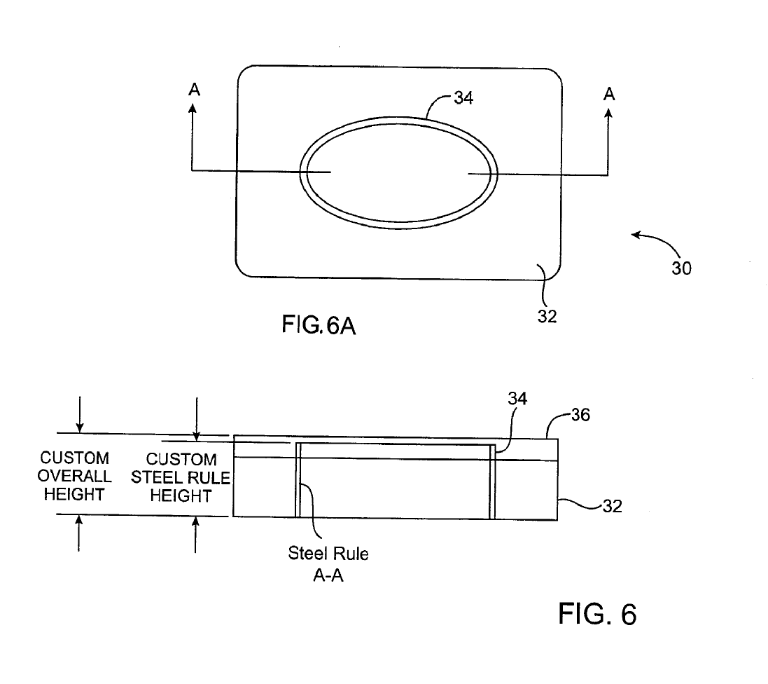

As shown in FIG. 6, in one embodiment a die 30 includes a base 32 housing a steel rule 34 that is configured to a shape to provide a corresponding cut out of the sheet material. A rubber material 36 is adhered to the top portion of the base. The rubber portion extends beyond the top portion of the cutting edge of the steel rule so as to maintain the sharpness of the steel rule 34. The rubber 36 also provides an ejection or a spring back force to extract the sheet and desired shape cut out of the sheet from the die after the die press is actuated and the cutting action has been performed.

The consumer die includes a steel rule with a custom steel rule die height. For example, the custom steel rule height is a height that is custom made in batches for the consumer die press. In contrast, steel rule may be purchased in bulk from a supplier in which the steel rule is of a common height, such as half an inch which would not cooperate in the cutting area of the press. For example, consumer dies with custom steel rule heights and custom overall heights have been utilized by the present inventors using a 0.622 inch steel rule height which is a non-standard steel rule height that cannot be purchased off of the shelf from the supplier nor purchased in bulk. By manufacturing the consumer dies according to the present disclosure, off of the shelf steel rule may not be used with the consumer press with a defined cutting height. Since a custom steel rule height is utilized in the consumer dies, the consumer dies have a custom overall height as well. Therefore, the consumer dies of the present disclosure may only be utilized with the consumer press with the cutting area as defined herein. Further, as described above, the consumer die of the present disclosure may be utilized with the commercial press only if an adapter is incorporated into the die combination to make up for the difference of the commercial die cutting height and the consumer die cutting height. Users may be interested in using consumers dies on commercial die presses because consumers die typically have a lower retail cost compared to commercial dies.

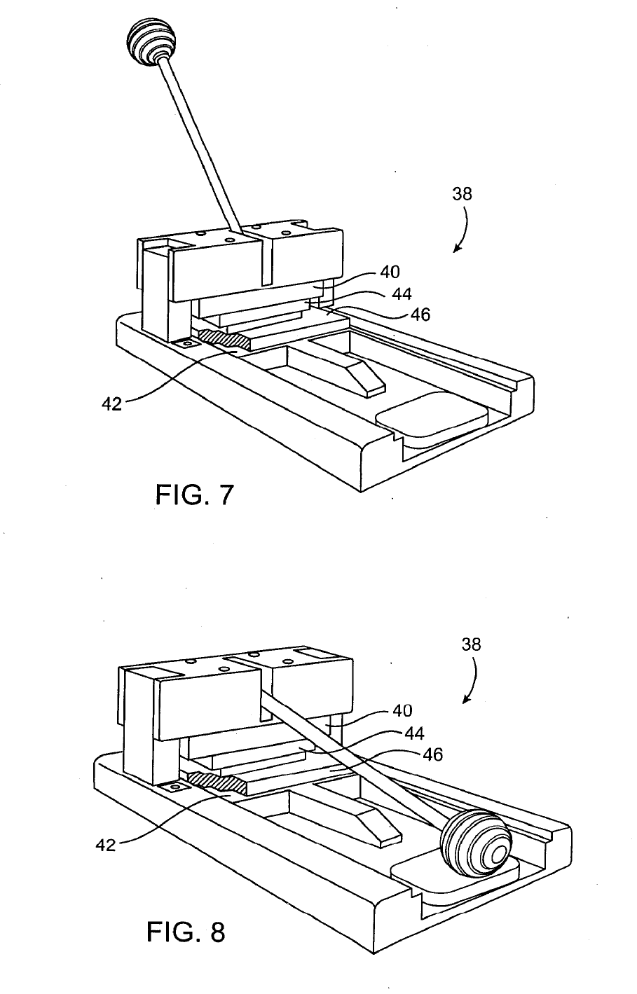

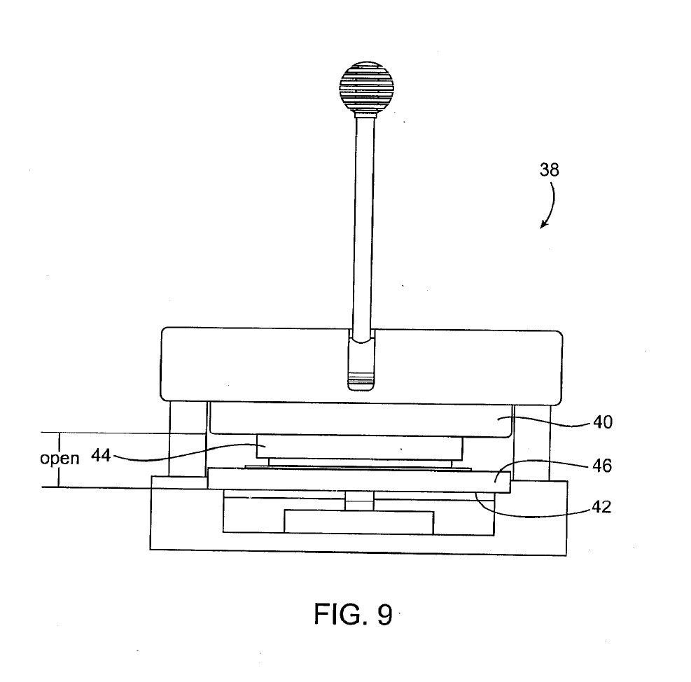

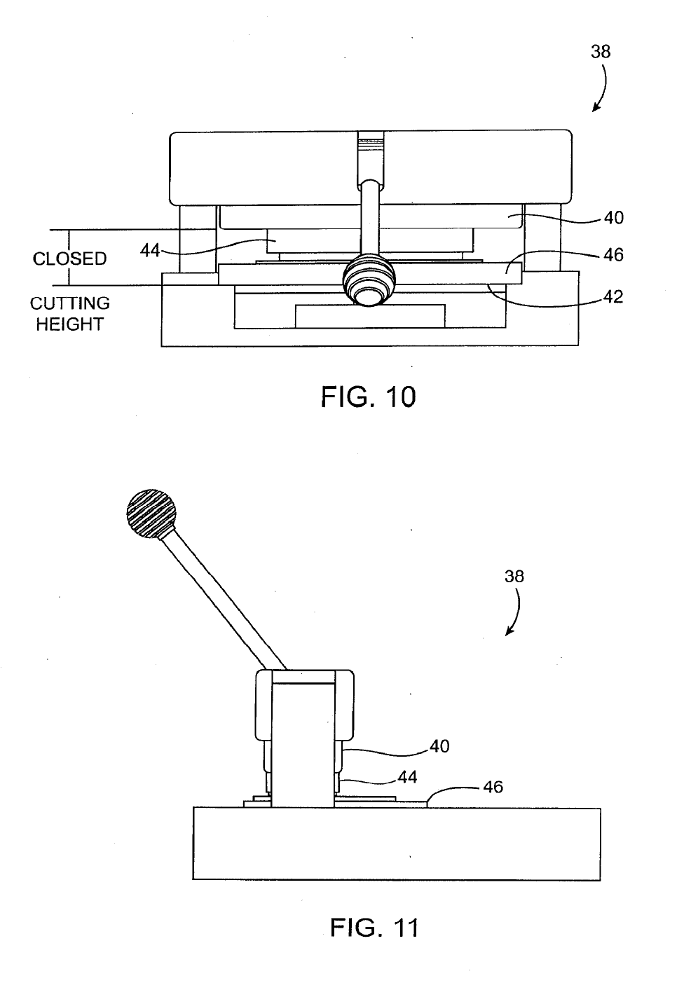

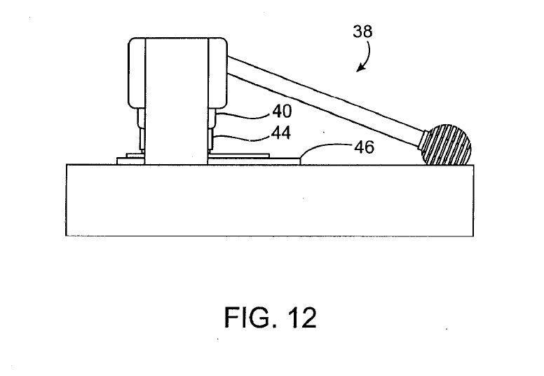

FIG. 7 illustrates a consumer die press 38 in an open position with an upper platen 40 and a lower platen or base 42 with a die 44 and a cutting pad 46. FIG. 8 illustrates the consumer die press in a closed position. FIG. 9 illustrates the consumer press 38 in an open position defining a consumer press working, or open area. FIG. 10 illustrates the consumer press 38 in a closed position defining a consumer press cutting height. FIG. 11 further illustrates the consumer press 38 in an open position and FIG. 12 further illustrates the consumer press 38 in a closed position.

By way of example, a consumer die has successfully been manufactured by the inventors utilizing an overall height of 0.680 inches which is the height measurement with the rubber layer on the base. If the rubber layer is removed, then the overall height of the consumer die is 0.622 inches, which matches the height of the steel rule. Further, a consumer press has successfully been made utilizing a cutting pad thickness between the range of 0.312 to 0.317 inches. The die cutting height is 0.616 to 0.628 inches, when the machine is open, the working or open area is 1.125 to 1.130 inches, and when the machine is closed, the die press cutting height is 0.920 to 0.924 inches.

FIG. 13 illustrates an embodiment of the adapter. The adapter 1300 has a recessed flat portion 1302 that is adapted to be positioned onto an upper or lower platen in a die press. When the adapter 1300 is positioned onto the platen, a first raised ridge 1304 and a second raised flange 1306 overlap the edges of the platen to align the adapter onto the platen. The adapter 1300 also has a one way magnet 1308 to removeably attach the adapter 1300 to the platen, since the platen is made of a metal alloy. The magnet is a one way magnet, with alternating polarization so that the magnet does not interfere with the steel rule, the chemical etched, or other die in the working area between the platens. A counterbore is placed in the adapter so that the magnet may be recessed into the adapter. The magnet is secured into the counterbore with an adhesive, such as glue, or the magnet may be mechanically attached to the counterbore. For example, the converter may be clipped, bolted, or otherwise attached to the platen. In the alternative, a combination of an adhesive and a mechanical connection may be utilized to secure the magnet to the adapter.

The adapter 1300 is made of a bar stock that has a plurality of through holes 1310 through the adapter to lighten the weight of the adapter. As shown in FIG. 14, the adapter may have a thickness D that allows consumer dies to be used in a consumer press, or thin dies to be used in a commercial press, or thin dies to be used in a consumer press. Several adapters may be utilized, which would allow each combination of dies and presses to be utilized together.

The adapter disclosed herein, with a certain thickness allows consumer dies to be used in a commercial press. An adapter of a different thickness would allow thin dies to be used in a commercial press. An adapter of yet a different thickness would allow thin dies to be used in a consumer press. Each adapter would accommodate for the cutting height difference of the components. For example, the adapter would accommodate for the difference in the commercial press cutting height minus the consumer press cutting height, plus any difference in the dies being used, such as difference between the height of a commercial die versus the height of a thin die.

Although this invention has been shown and described with respect to detailed embodiments, those skilled in the art will understand that various changes in form and detail may be made without departing from the scope of the disclosed invention. For example, the pad and/or adapter may be made from any material, such as wood, plastic, composites, to name only a few. Also, instead of using cutting dies, embossing templates could be utilized or pressing blocks to press flowers or the like. In addition, the adapter or pad could be fixed, hinged, loose, glued, magnetized, or any combination thereof and in any order, placement, or alignment of the adapter to the die press or the other components may be utilized. A shuttle case with a shim or other component could also be utilized. If the components are magnetized, the components could be attached to a platen, the die, or the shuttle.

What is claimed is:

1. A die press system, comprising:
a die adapted to be located in a working area of a press, the die having a first cutting height corresponding to a cutting height of the press; and
an adapter having a height that is generally approximately equal to the difference between a second cutting height and the first cutting height, and configured to adapt the die for use at the second cutting height.

2. The system of claim 1, wherein the adapter comprises a cutting pad.

3. The system of claim 2, wherein the cutting pad has a thickness between 0.312 to 0.317 inches.

4. The system of claim 1, wherein the adapter comprises bar stock having a recessed flat portion adapted to be positioned onto a die press platen.

5. The system of claim 1, wherein the adapter comprises at least one raised ridge configured to align the adapter relative to a die press platen.

6. The system of claim 1, wherein the adapter comprises a magnet configured to removeably attach the adapter to a die press platen.

7. The system of claim 6, wherein the magnet is positioned within a counterbore in the adapter.

8. The system of claim 1, wherein the die comprises a steel rule die.

9. The system of claim 1, wherein the die comprises a chemical etched die.

10. The system of claim 1, wherein the first cutting height of the die is 0.616 to 0.628 inches.

11. A die press system, comprising:
a die having a height configured for a first cutting height;
a cutting pad; and
an adapter configured for use with the die and the cutting pad to enable use of the die in a press having a second cutting height, wherein the second cutting height is larger than the first cutting height.

12. The system of claim 11, wherein the first cutting height of the die is 0.616 to 0.628 inches.

13. The system of claim 11, wherein the cutting pad has a thickness between 0.312 to 0.317 inches.
